(19) United States
(12) Patent Application Publication
(10) Pub. No.: US 2025/0300944 A1
(43) Pub. Date: Sep. 25, 2025

(54) ML-BASED TRIGGERING FOR PAYLOAD MANAGEMENT

(71) Applicant: AisleAI, Inc., Tempe, AZ (US)

(72) Inventor: Kevin J. Senn, Danville, CA (US)

(73) Assignee: AisleAI, Inc., Tempe, AZ (US)

(21) Appl. No.: 19/090,147

(22) Filed: Mar. 25, 2025

Related U.S. Application Data
(60) Provisional application No. 63/569,611, filed on Mar. 25, 2024.

(51) Int. Cl. H04L 47/83; H04L 47/50

(52) U.S. Cl. CPC H04L 47/83; H04L 47/50

(57) ABSTRACT

A utilization prediction method to manage payload allocation at a cloud network. The utilization prediction method involves preprocessing datasets, including temporal, geospatial, demographic, and storage-based datasets. The utilization prediction method further involves interpolating and modulating the datasets associated with an instance via a machine learning engine. The machine learning engine determines the magnitude of the instance, predicts a payload utilization rate, determines nodes at a map for payload allocation, and schedules payload transmission across the nodes within a time frame. The machine learning engine further triggers payload transmission based on a prediction outcome, maintains a buffer payload at nodes, monitors the payload utilization rate at a stage gate, and transforms the prediction outcome based on input from the stage gate and a feedback loop. Finally, the utilization prediction method includes validating the prediction outcome against external telemetry and displaying the prediction outcome, nodes, and alerts at a user interface.

### PRIORITY

This application is a non-provisional of and claims priority to U.S. Provisional Patent Application No. 63/569,611, filed Mar. 25, 2024, which is incorporated herein by reference in its entirety.

### BACKGROUND

This disclosure relates, in general, to payload management systems and, not by way of limitation, to payload allocation using machine learning techniques, among other things.

Payload management involves distributing payloads to various retail locations to meet required utilization rates. An effective distribution flow helps manage storage issues, handle overheads, and enhance customer satisfaction. Predicting a utilization rate and a payload flow employs various conventional schemes. For example, heuristic methods are based on historical utilization patterns, predefined thresholds, time division multiple access (TDMA) allocating slots to different payloads, mobility awareness, and/or priority-based allocations. The dynamic nature of the utilization rate,, payload misalignment, memory overhead, sudden events, and/or weather effects on foot traffic are common variables to consider while predicting the utilization rate.

Short-term demand spikes from events are a big challenge in payload allocation, which can lead to overstocking or stockouts. These sudden changes in consumer behavior can overwhelm inventory systems, resulting in either excess stock that ties up capital or insufficient stock that fails to meet customer demand. Another challenge is inconsistent data on actual shelf conditions, which impacts the accuracy of demand fulfillment. Without reliable information on what is available on shelves, it becomes difficult to accurately predict and respond to consumer needs. Additionally, the absence of comparative data from competitors hinders the ability to measure the effectiveness of integrated data-driven strategies. Without benchmarking against industry standards, it is challenging to assess whether current practices are optimal or if improvements are needed. Addressing these issues through efficient payload allocation can help maintain balanced inventory levels, improve demand forecasting, and enhance competitive positioning. However, advanced technology can improve the management of payload flow and the prediction of utilization rates, boosting an organization's productivity and efficiency.

### SUMMARY

In one embodiment, the present disclosure provides a utilization prediction method to manage payload allocation at a cloud network. The utilization prediction method involves preprocessing datasets including temporal, geospatial, demographic, and storage-based datasets. The utilization prediction method further involves interpolating and modulating the datasets associated with an instance, via a machine learning engine. The machine learning engine determines the magnitude of the instance, predicts a payload utilization rate, determines nodes at a map for payload allocation, and schedules payload transmission across the nodes within a time frame. The machine learning engine further triggers payload transmission based on a prediction outcome, maintains a buffer payload at nodes, monitors the payload utilization rate at a stage gate, and transforms the prediction outcome based on an input from the stage gate and a feedback loop. Finally, the utilization prediction method includes validating the prediction outcome against external telemetry and displaying the prediction outcome, nodes, and alerts at a user interface.

In an embodiment, a utilization prediction method to manage payload allocation in a cloud network. In one step, the utilization prediction method involves preprocessing datasets including temporal, geospatial, demographic, and storage-based datasets, that are extracted from various databases. The utilization prediction method further involves interpolating the datasets associated with an instance and modulating the datasets via a machine learning engine. The instance indicates a projected interruption in a set transmission process. The machine learning engine determines the magnitude of the instance, predicts a payload utilization rate based on the magnitude, determines nodes at a map for payload allocation, and schedules payload transmission across the nodes within a time frame. The machine learning engine further triggers payload transmission based on a prediction outcome, maintains a buffer payload at nodes, monitors the payload utilization rate at a stage gate, and transforms the prediction outcome based on an input from the stage gate and a feedback loop. The prediction outcome corresponds to the payload utilization rate for the instance and the buffer payload is an offset for an error in the prediction outcome. Finally, the utilization prediction method includes validating the prediction outcome against external telemetry and displaying the prediction outcome, nodes, and alerts at a user interface. The temporal dataset includes information of the instance recorded multiple timestamps that provide a baseline pattern to the machine learning engine. The geospatial datasets include information about an instance timeline, foot traffic count, and geolocated movement patterns sourced from electronic device tracking. The demographic datasets include geographic coordinates such as latitude and longitude, geographic boundaries, and/or demographic variables for the nodes. The storage-based datasets include information about storage capacity and payload condition at the node and are determined from image recognition of images of payloads. The images are received via sensors integrated within a node premise.

In an embodiment, a utilization prediction system to manage payload allocation in a cloud network. The utilization prediction system preprocesses datasets including temporal, geospatial, demographic, and storage-based datasets, that are extracted from various databases. The utilization prediction system further interpolates the datasets associated with an instance and modulates the datasets via a machine learning engine. The instance indicates a projected interruption in a set transmission process. The machine learning engine determines the magnitude of the instance, predicts a payload utilization rate based on the magnitude, determines nodes at a map for payload allocation, and schedules payload transmission across the nodes within a time frame. The machine learning engine further triggers payload transmission based on a prediction outcome, maintains a buffer payload at nodes, monitors the payload utilization rate at a stage gate, and transforms the prediction outcome based on an input from the stage gate and a feedback loop. The prediction outcome corresponds to the payload utilization rate for the instance and the buffer payload is an offset for an error in the prediction outcome. Finally, the utilization prediction system validates the prediction outcome against external telemetry and displays the prediction outcome, nodes, and alerts at a user interface. The temporal dataset includes information of the instance recorded multiple timestamps that provide a baseline pattern to the machine learning engine. The geospatial datasets include information about an instance timeline, foot traffic count, and geolocated movement patterns sourced from electronic device tracking. The demographic datasets include geographic coordinates such as latitude and longitude, geographic boundaries, and/or demographic variables for the nodes. The storage-based datasets include information about storage capacity and payload condition at the node and are determined from image recognition of images of payloads. The images are received via sensors integrated within a node premise.

In yet another embodiment, a computer-readable media is discussed having computer-executable instructions embodied thereon that when executed by one or more processors, facilitate utilization prediction method to manage payload allocation in a cloud network. In one step, the utilization prediction method involves preprocessing datasets including temporal, geospatial, demographic, and storage-based datasets, that are extracted from various databases. The utilization prediction method further involves interpolating the datasets associated with an instance and modulating the datasets via a machine learning engine. The instance indicates a projected interruption in a set transmission process. The machine learning engine determines the magnitude of the instance, predicts a payload utilization rate based on the magnitude, determines nodes at a map for payload allocation, and schedules payload transmission across the nodes within a time frame. The machine learning engine further triggers payload transmission based on a prediction outcome, maintains a buffer payload at nodes, monitors the payload utilization rate at a stage gate, and transforms the prediction outcome based on an input from the stage gate and a feedback loop. The prediction outcome corresponds to the payload utilization rate for the instance and the buffer payload is an offset for an error in the prediction outcome. Finally, the utilization prediction method includes validating the prediction outcome against external telemetry and displaying the prediction outcome, nodes, and alerts at a user interface. The temporal dataset includes information of the instance recorded multiple timestamps that provide a baseline pattern to the machine learning engine. The geospatial datasets include information about an instance timeline, foot traffic count, and geolocated movement patterns sourced from electronic device tracking. The demographic datasets include geographic coordinates such as latitude and longitude, geographic boundaries, and/or demographic variables for the nodes. The storage-based datasets include information about storage capacity and payload condition at the node and are determined from image recognition of images of payloads. The images are received via sensors integrated within a node premise.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 illustrates a block diagram of an embodiment of a utilization prediction system to manage payload allocation at a cloud network;

FIG. 2 illustrates a consumer behavior graph demonstrating payload demand patterns ahead of a football match;

FIG. 3 illustrates a data flow diagram for accumulating different datasets into a meta database;

FIG. 4 illustrates a block diagram of preprocessing the datasets that are extracted from multiple databases;

FIG. 5 illustrates a block diagram of an embodiment of a machine learning engine of the utilization prediction system;

FIG. 6 illustrates a block diagram for validating a prediction outcome against an external telemetry;

FIG. 7 illustrates graphical representations of a predicted outcome and an actual utilization rate of an instance and their comparison;

FIGS. 8A-8B illustrate agent dashboards presented in a user interface for an agent to manage payload allocation;

FIG. 9 illustrates a payload utilization method to manage the payload allocation at the cloud network; and

FIG. 10 illustrates a flow chart for scheduling and triggering payload transmission by preprocessing the datasets.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

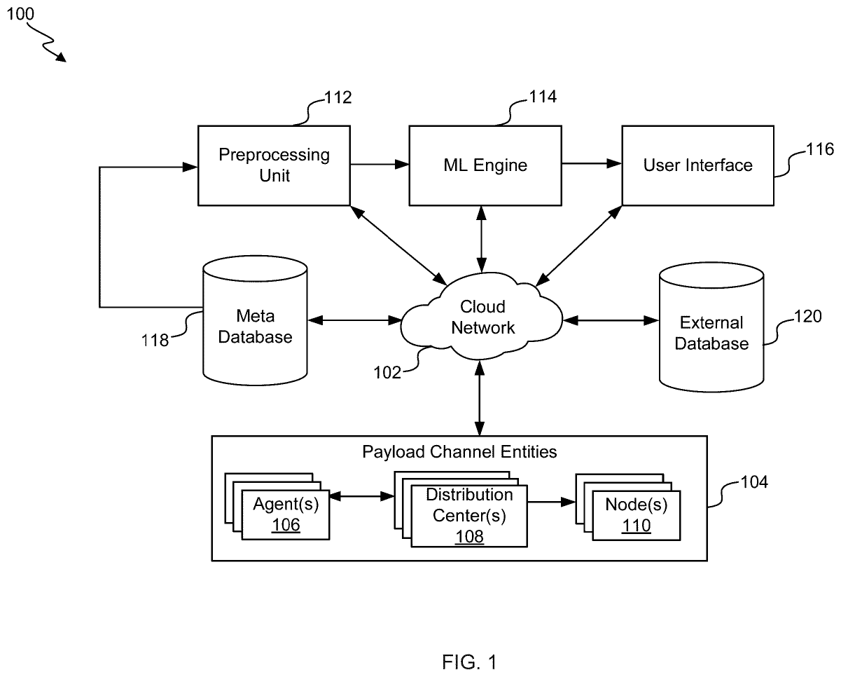

Referring to FIG. 1, a block diagram of an embodiment of a utilization prediction system 100 to manage payload allocation at a cloud network 102, is shown. The utilization prediction system 100 provides a flow maximization mechanism to manage payload provision for an upcoming instance. An instance indicates a projected interruption in a set transmission process of an organization. For example, a football match, a music festival, etc. In this application, the terms “instance” and “event” are used interchangeably. An upcoming football match is an indicator of a setback in the set transmission process of a beverage manufacturing company. The company must deliver an increased payload to nearby stores to meet the anticipated surge in demand. A payload refers to the manufactured goods of the organization. In this application, the terms “payload,” “product,” and “resource” are used interchangeably. For this example, the payload refers to the quantity of beverages that the company needs to deliver to nearby stores to meet the increased demand due to the upcoming football match. Failure to supply on time or adequately meet the surge in demand could negatively impact the company's business and reputation.

The utilization prediction system 100 provides a forecast of a payload utilization rate for the upcoming event to mitigate such issues. The utilization prediction system 100 uses machine learning (ML) techniques to correlate geographically granular instance data with point-of-sale (POS) scan data and individual demographics obtained from mobile device tracking. The utilization prediction system 100 schedules payload transmission across different nodes within a time frame i.e., 3 days before the instance. The utilization prediction system 100 further triggers payload transmission to nearby stores based on its prediction outcome. In this way, the utilization prediction system 100 provides true demand forecasting, efficient inventory allocation, and actionable insights for competitive benchmarking. The utilization prediction system 100 includes the cloud network 102, payload channel entities 104, a preprocessing unit 112, an ML engine 114, a user interface 116, a meta database 118, and an external database 120. The payload channel entities 104 include agent(s) 106, distribution center(s) 108, and node(s) 110.

The cloud network 102 allows real-time data exchange between the payload channel entities 104, the ML engine 114, and various databases. The payload channel entities 104 manage and coordinate payload transmission from the agent 106 to the nodes 110. The agent 106 can be an acquisition source (i.e., a supplier) and/or a fabrication unit (i.e., a manufacturer). The distribution centers 108 are facilities designed to manage the payload's storage, processing, and movement. For example, a warehouse of an organization, etc. The distribution centers 108 receives payloads from different agents and sorts and stores these payloads for a period. The distribution centers 108 distribute the payload to various nodes depending on the supply-demand and product availability. The distribution centers 108 also coordinate with the agents 106 to align the quantities of the payloads with the demand forecast. The nodes 110 include a retail location, point-of-sale outlets, customers, or a storefront. The customers buy the payloads from the retail location (i.e., the node 110), and their purchase data is stored as point-of-sale (POS) scan data. The terms “nodes” and “stores” are used interchangeably in this application. The payload channel entities 104 are connected to others via the cloud network 102.

The preprocessing unit 112 receives the POS scan data and datasets stored in the meta database 118. The preprocessing unit 112 functions to clean and normalize the datasets by removing duplicates and aligning timestamps. The preprocessing unit 112 geographically aligns the event and the POS scan data using geo-hashing or latitude-longitude matching techniques. In one embodiment, the preprocessing unit 112 engineers feature such as “distance to the event,” “event size,” and “time to event” to enhance data quality and relevance for further analysis. The meta database 118 stores the preprocessed datasets, including temporal, geospatial, demographical, and/or storage-based datasets and the POS scan data. The POS scan data is used as a baseline for the ML engine 114 to predict the payloads' demand forecast or utilization rate.

The ML engine 114 modulates the datasets that are associated with the instance or event (i.e., the impact of weather on foot traffic during that event, seasonal trends, demographic behaviors, etc.). The ML engine 114 identifies the magnitude of the instance from multiple datasets and predicts the payload utilization rate based on this magnitude. The instance's magnitude refers to the event's scale or impact. The ML engine 114 further determines nodes on a map for the payload allocation and schedules payload transmission across these nodes within a specified time frame. The ML engine 114 also triggers the payload transmission based on the predicted utilization rate, maintains a buffer payload at the nodes to offset prediction errors, monitors the payload utilization rate at a stage gate, and adjusts a prediction outcome using inputs from the stage gate and a feedback loop.

The user interface 116 provides real-time actionable recommendations and alerts on a dashboard. The agents 106 receive payload's shelf condition alerts, predicted sales lift for stock-keeping units (SKUs) during events, and consumer behavior segmentation insights via the user interface 116. The user interface 116 offers visualizations for actionable business insights and predictive models for SKU demand during and after the events. The user interface 116 enables the agents 106 to make informed decisions based on accurate predictions, trends, and demand forecasts, ensuring seamless payload allocation and retail execution.

The external database 120 stores external telemetry (i.e., distributional data of the adversaries/competitors) that is used for validating prediction outcomes. The external database 120 collects and maintains telemetry data from various sources at the cloud network 102, which is then used to compare and validate the accuracy of predictive models. By incorporating the adversary's distribution data results as a control group, the utilization prediction system 100 can scale improvements and assess SKU-level sales changes during similar events. Validating the prediction outcome confirms that the predictions are accurate, effective in real-world scenarios, and useful for payload allocation.

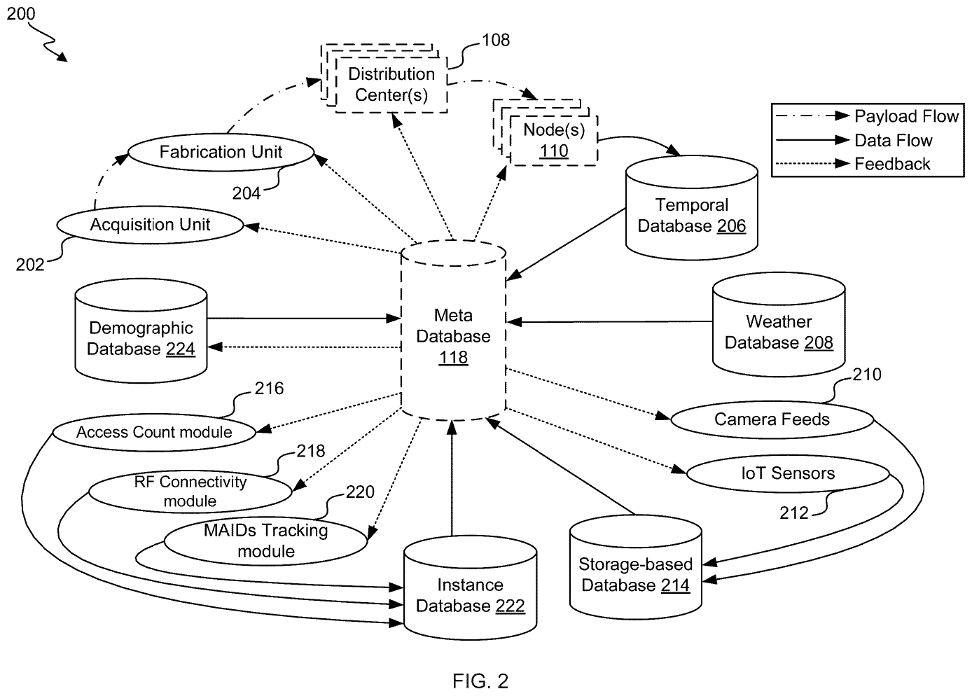

Referring next to FIG. 2, a data flow diagram 200 for accumulating different datasets into a meta database 118 is shown as an embodiment. The data flow diagram 200 shows different datasets used to predict the payload utilization rate during/before the instance/event, where the weather conditions influence foot traffic. The meta database 118 is a centralized database that collects the datasets related to the payload allocation and transmission process. The meta database 118 includes the datasets from different databases that affect the demand prediction and the payload allocation. The meta database 118 analyzes the datasets and sends feedback to supply chain participants (i.e., an acquisition unit 202, a fabrication unit 204, the distribution centers 108, and the nodes 110) to meet the payload needs. The feedback includes information on supply chain performance, forecasting, inventory management, event-driven shelf conditions at the retail locations, and product flow

The acquisition unit 202 provides base material for the fabrication unit 204 as per the market demand. The fabrication unit 204 makes and sends the product to the distribution centers 108. The distribution centers 108 sorts and stores the received payload/products, manages the product flow to different retail locations and coordinates with fabrication units 204 and nodes 110 for further payload processing. The storage-based database 214 includes storage-based datasets that verify real-time shelf conditions of the products. The storage-based datasets include information about storage capacity and payload condition at the nodes 110 which is determined from image recognition of images of the payloads. The images are received via sensors integrated within a node premise. The storage-based datasets help identify and address out-of-stock issues, product facings, and planogram compliance before the events and during test periods to validate results.

Camera feeds 210 at the nodes 110 provide information regarding visual monitoring, capturing product placement and stock levels images/videos, which are further analyzed using image recognition software. The camera feeds 210 also provides information about customer interaction with the products, such as which areas of the shelf are visited frequently and what are the visibility points for a target product. IoT sensors 212 detect environmental conditions for the products, monitor the quantity of the products on the shelves, alert staff when the quantity goes below a threshold, and identify which products are being picked up frequently. The camera feeds data and the IoT sensors 212 data are combined in the storage-based database 214 to create storage-based datasets. The storage-based datasets are provided to the meta database 118, which are then analyzed to check the shelf performance and the product flow. By ensuring optimal shelf conditions, the storage-based datasets enhance accuracy of demand forecasts and improve retail execution.

The temporal database 206 stores temporal datasets that indicate the POS scan data. The POS scan data includes sales data from independent nodes/convenience stores, with granularity at the SKU level, timestamped, and geolocated. The POS scan data further includes product information, quantities bought, and transaction details, including total amount, payment type, and transaction time. The POS scan data further includes inventory data helping track the stock levels and future demands, customer buying behavior, visit frequencies, staff activity, transaction processes by a staff member x, payment methods, etc. The POS scan data is received and stored in the temporal database 206. When the product is purchased, the POS scan data gets updated. The temporal datasets include temporal variables like year, hour, minute, day, or second, along with attributes that represent the characteristics or measurements recorded at every single time point, such as temperature, stock prices, or sales figures. The temporal database 206 provides baseline POS scan data to the meta database 118. The temporal dataset includes information on the instance recorded at multiple timestamps that provide a baseline pattern to the ML engine 114. The temporal datasets provide detailed insights into sales patterns and help with accurate payload utilization prediction.

The weather database 208 includes a wide range of data collected from various sources. Weather conditions affect attendance or product preferences, such as increased demand for bottled water during hot weather. This data helps adjust predictions based on external factors. The weather database 208 includes temperature data for current, historical, and future timelines. The weather database 208 also includes atmospheric moisture content, rainfall records, snowfall information, visibility conditions, weather conditions, historical weather data, and predictions of future weather conditions. Data provided by the weather database 208 is used to find the dependency of foot count during the event on the weather. For example, a hot weather prediction for an upcoming football match can increase the sales of cold drinks. Hence, more payload (cold beverages) needs to be allocated to the nearby nodes (stores).

The instance database 222 stores geospatial datasets that include information about instance timelines (i.e., planned or unexpected events happening or scheduled to happen in a geographic boundary). The geospatial datasets further include foot traffic count, i.e., crowd size estimates from event attendance data, geolocated movement patterns sourced from mobile device tracking or event organizers, and related event metadata (type, duration, seasonality). The geospatial datasets help correlate consumer behavior with sales trends during the events/instances. An access count module 216 provides information about event attendees using ticket scanners, manual counters, and/or the total number of event seat bookings.

The access count module 216 can also use cameras with image recognition software to count people entering or exiting the event's geographic boundary. IoT devices are also deployed to track several attendees in real-time. A radio frequency (RF) connectivity module 218 is employed to provide insights into the foot count during the instance/event. The RF connectivity module 218 includes Wireless Fidelity (Wi-Fi) and Bluetooth signal analysis from attendees' devices to estimate traffic and movement patterns. A mobile advertising IDs (MAIDs) tracking module 220 helps in identifying foot count across different social applications and sessions, tracks attendees' interaction with ads, and enables personalized ad experience. The MAIDs tracking module 220 helps to collect foot count by setting up virtual boundaries around the event locations. The data from the RF connectivity module 218, the MAIDs tracking module 220, and the access count module 216 are organized and stored in the instance database 222 as geospatial datasets. The instance database 222 stores tracking data for 3 days prior to and after the event/instance. Upon reaching a 26% match between the data from the RF connectivity module 218, the MAID tracking module 220, and the access count module 216, the geospatial dataset is created. The geospatial datasets help in identifying high traffic zones, event details, location, peak times, flow patterns, or other related factors.

The demographic database 224 stores demographic datasets that provide information about the retail locations. The demographic database 224 stores node's data based on their geographical locations and demographic attributes. The demographic datasets include geographic coordinates, such as latitude and longitude, geographic boundaries, and/or demographic variables for the retail locations, such as store size, operational hours, and historical sales performance. These characteristics provide context for sales data and help refine payload utilization forecasts.

The data from the instance database 222, the weather database 208, the demographic database 224, and the storage-based database 214 are sent to the meta database 118. The meta database 118 stores the datasets, organizes and analyzes patterns, and sends feedback to different nodes when needed. The feedback from the meta database 118 can include feedback on the distribution decision or the agent performance to the fabrication unit 204 and the acquisition unit 202, the feedback on the POS scan data discrepancy to the nodes 110, etc. The meta database 118 sends feedback to the demographic database 224 when a node is falsely categorized or has been removed from certain demographics. The meta database 118 also provides feedback to the camera feeds 210 and the IoT sensors 212 if a product is falsely categorized by the image recognition system or if the movement of the product from the shelf does not match with the potential inventory levels. The meta database 118 provides feedback to the RF connectivity module 218, the MAIDs tracking module 220, and the access count module 216 if the reported foot traffic varies greatly from the actual foot traffic, etc.

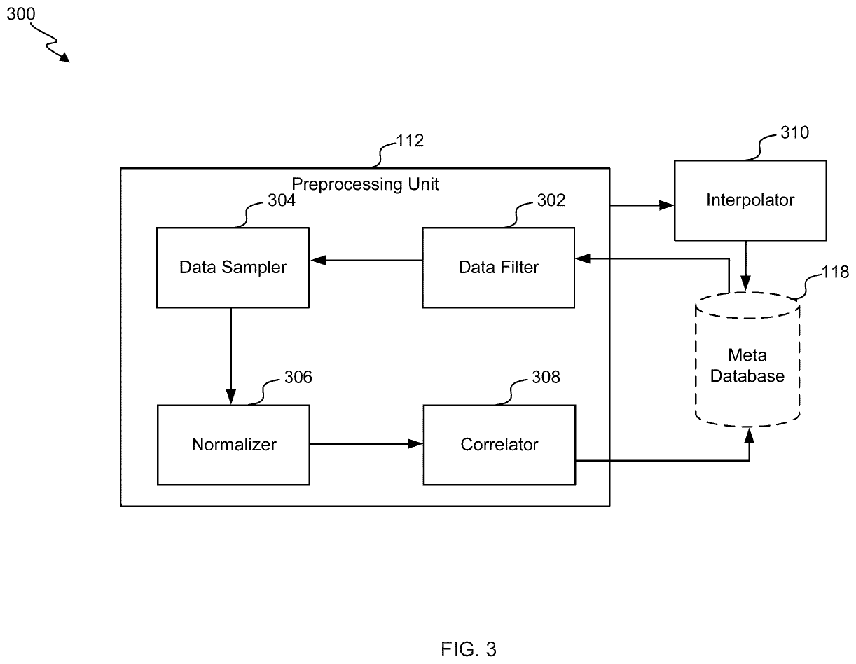

Referring to FIG. 3, a block diagram of preprocessing 300 datasets extracted from multiple databases is shown as an embodiment. The preprocessing unit 112 of the utilization prediction system 100 includes a data filter 302, a data sampler 304, a normalizer 306, and a correlator 308. The preprocessing unit 112 takes datasets from the meta database 118 that are associated with the instance and sets up baseline datasets for the ML engine 114. The data filter 302 is responsible for cleaning the datasets by removing duplicates and irrelevant information. The data filter 302 can remove outliers from the datasets to maintain consistency. The data filter 302 ensures that only high-quality, relevant data is passed on to the ML engine 114. The data filter 302 can remove redundant POS scan data and irrelevant event information, ensuring that the dataset is accurate and reliable.

The data sampler 304 selects a representative subset of data from the larger dataset. This may help manage large volumes of data and ensure the analysis is efficient and scalable. For example, the data sampler 304 might select a subset of the POS scan data and event-driven people count data to create a manageable dataset for predictive modeling. The normalizer 306 aligns timestamps and standardizes data formats to ensure consistency across the datasets. This includes geographically aligning event data and the POS scan data using geo-hashing or latitude-longitude matching. By normalizing the datasets, the preprocessing unit 112 ensures that all data points are comparable and can be accurately analyzed.

The correlator 308 generates dependency mappings and engineers features such as “distance to event,” “event size,” and “time to event mappings.” These features are used to increase the accuracy of the predictive prediction of the ML engine 114. The correlator 308 sets up a correlation between the independent and control variables of the datasets. The independent variables include the POS scan data, the even-driven people count data, and the payload's shelf-condition data. The control variables include historical and real-time weather data, node (store/outlet) characteristics data, etc. By correlating different data points, the preprocessing unit 112 helps identify patterns and relationships that are needed for payload utilization forecasting, payload allocation, and inventory management.

The preprocessed data is fed into an interpolator 310 of the utilization prediction system 100. The interpolator 310 takes the processed data and fills in gaps or predicts intermediate values based on the surrounding data. For example, a newly established node has less than 365 days of sales data. The preprocessing unit 112 does not consider this data irrelevant, rather missing values are estimated to create a continuous dataset via the interpolator 310. The interpolator 310 identifies missing data periods and employs an interpolation method. The interpolation method, like linear interpolation, spline interpolation, or polynomial interpolation, is then selected. The selected interpolation method is used to estimate sales data for the missing data periods, with linear interpolation often involving calculating the average sales between two known data points to fill in the gaps. The interpolated values are validated by comparing them with known data points by cross-referencing with external data sources or historical trends. Additionally, adjustments for seasonality and trends are made to reflect realistic sales behavior, incorporating known seasonal peaks or troughs. In this way, the interpolator 310 generates a complete dataset that represents sales trends, even for nodes with incomplete data. This creates a continuous dataset from discrete data points that are fed into the ML engine 114 to predict the payload utilization rate for the instance.

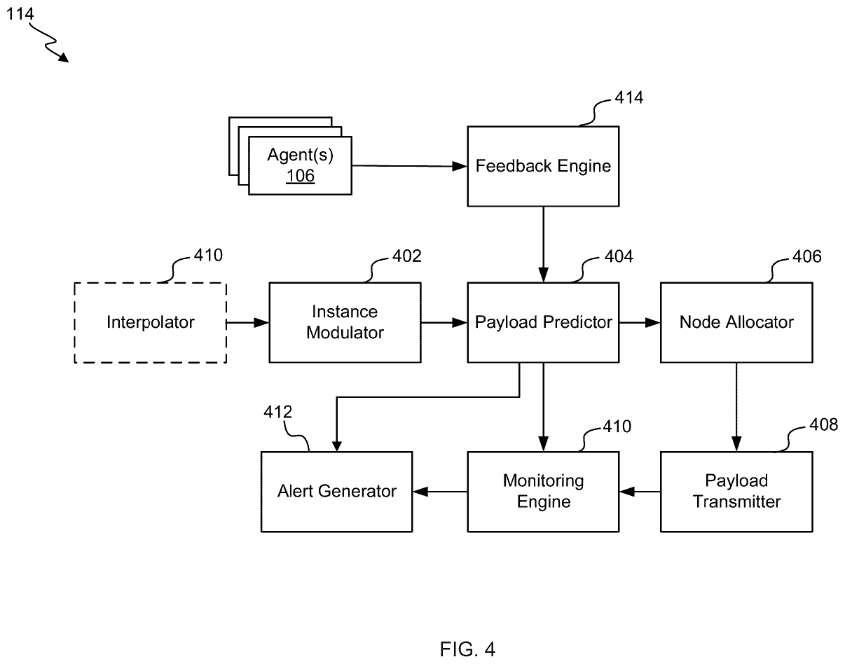

Referring next to FIG. 4, a block diagram of an embodiment of the ML engine 114 of the utilization prediction system 100 is shown as an embodiment. The ML engine 114 modulates the datasets associated with the instance. The ML engine 114 includes an instance modulator 402, a payload predictor 404, a node allocator 406, a payload transmitter 408, a monitoring engine 410, an alert generator 412, and a feedback engine 414. The ML engine 114 identifies the magnitude of the instance from the datasets and predicts the payload utilization rate based on the identified magnitude. The ML engine 114 determines the nodes 110 on the map for the payload allocation and schedules the payload transmission across the nodes within the specified time frame. The ML engine 114 triggers the payload transmission based on the predicted utilization rate and maintains the buffer payload at the nodes to offset any errors in the prediction outcome. The ML engine 114 further monitors the payload utilization rate at the stage gate and transforms the prediction outcome using inputs from the stage gate and the feedback loop. In one embodiment, the ML engine 114 deploys predictive models in an online prediction pipeline using a cloud platform such as Amazon Web Services (AWS), Google Cloud Platform (GCP), and/or Azure. The ML engine 114 can further stream real-time POS, MAIDs, and event data for continuous predictions.

The instance modulator 402 of the ML engine 114 receives datasets from the interpolator 310. The instance modulator 402 dynamically adjusts input variables, such as historical sales data, event attendance estimates, and weather conditions, to reflect real-time changes and anomalies. The instance modulator 402 transforms the datasets to enhance the signal processing, improving the performance of the ML engine 114 and adapting the datasets for the prediction outcome and the inventory management before/during the instance. The instance modulator 402 creates varied signal characteristics using techniques like amplitude modulation (AM), frequency modulation (FM), or quadrature amplitude modulation (QAM), which help in training learning models effectively. In one embodiment, the instance modulator 402 generates synthetic datasets from the datasets to challenge and improve the robustness of ML engine 114. In another embodiment, the instance modulator 402 applies data augmentation on the datasets to make them suitable for different models with different performance characteristics. For example, fast but less accurate ML engine vs. slow but highly accurate ML engine.

The instance modulator 402 transforms the datasets to ensure comparability across variables and incorporates external factors, such as competitor promotions, economic indicators, and social media trends, that might influence the demand. During the event, the instance modulator 402 continuously updates the payload predictor 404 with real-time data, such as live POS scan data and crowd size estimates, refining demand forecasts and payload utilization rates and providing actionable insights. The payload predictor 404 forecasts the magnitude of the instance and returns the prediction outcome. The prediction outcome indicates the payload utilization rate/product demand based on the magnitude of the instance. For instance, for the beverage making company, the payload predictor 404 predicts the number of beverages needed for the football match based on expected attendance and historical sales data. A national-level football match will have a higher impact or magnitude than a local-club football match. The payload predictor 404 makes predictions based on the independent variables (event data, shelf condition data, consumer behavior data, weather data, node/store characteristics, time factors, etc.) and the dependent variables (sales volume, etc.).

The payload predictor 404 employs time series models (e.g., autoregressive integrated moving average (ARIMA), and Prophet) combined with external regressors for event data to scale the magnitude of the instance. The payload predictor 404 considers consumer sales trends or behavioral patterns to estimate the payload utilization rate. Different clustering algorithms (e.g., k-means, and density-based spatial clustering of applications with noise (DBSCAN)) can be used for customer segmentation based on the demographics. For example, football match attendees are more likely to purchase alcoholic beverages than concert attendees. Payload predictor 404 further uses gradient boosting models (e.g., extreme gradient boosting (XGBoost), light gradient-boosting machine (LightGBM)), or neural networks to predict the payload utilization rate. In one embodiment, the payload predictor 404 can also calculate confidence metrics for the prediction outcome and generate recommendations and graphs using different components (not shown here).

The node allocator 406 determines optimal nodes on the map for the payload allocation. For example, the node allocator 406 identifies appropriate stores to receive additional stock based on their proximity to the event and historical sales performance. The node allocator 406 further pins the location of the instance and creates a polygon indicating the nearby nodes on the map. The polygon helps the users or agents 106 using the user interface 116 in locating the stores with available stock of a particular product/payload. A polygon boundary is not limited to certain nodes or regions; rather, it is based on the magnitude or scale of the instance. A bigger instance will have more nodes in its polygon to cater to the needs of a larger crowd.

The nodes determined from the node allocator 406 are fed into the payload transmitter 408. The payload transmitter 408 manages the scheduling, distribution, and transmission of the payload. The payload transmitter 408 schedules and triggers the transmission of payloads across the allocated nodes within the specified time frame. For example, for an upcoming football match, the payload transmitter 408 ensures timely delivery of beverages to stores before the event starts. The payload flow is triggered when an irregular surge or decrease in the payload utilization rate is detected. The payload flow is either accelerated or decelerated by the payload channel entities 104 based on the predicted payload utilization rate.

The monitoring engine 410 continuously monitors the payload utilization rate at the stage gate. The monitoring engine 410 tracks real-time sales data during the instance to ensure inventory levels are sufficient. The monitoring engine 410 uses historical data, market trends, and prediction outcomes to ensure inventory levels align with expected sales. The monitoring engine 410 maintains the buffer payload at the nodes 110 to protect against unexpected demand spikes or supply chain disruptions. The buffer payload is an offset for an error in the prediction outcome. This helps prevent stockouts in case of unexpected utilization spikes while avoiding excessive inventory. The monitoring engine 410 manages inventory across multiple locations and stage gates in the supply chain to balance payload stock-level throughout.

In one embodiment, the monitoring engine 410 creates a just-in-time (JIT) inventory by receiving the payload only as they are needed in a production process. This minimizes carrying costs and reduces the risk of overstocking. The monitoring engine 410 further adjusts the payload allocation based on real-time instance data. The alert generator 412 generates alerts based on the prediction outcome and real-time output of the monitoring engine 410. For instance, the alert generator 412 sends an alert to the agent 106 via the user interface 116 when a store is at risk of running out of stock during the event. The alerts can be based on the shelf condition of the payload. For example, the alert generator 412 can send reminders to the agents 106 that product XYZ is expiring in 7 days. So, agent(s) 106 can remove the product XYZ from the shelves in a timely manner and restock it with the newer payload. The feedback engine 414 transforms the prediction outcome using input from the monitoring engine 410 at the stage gate and the feedback loop. The feedback loop provides the feedback engine 414 with ongoing data inputs, post-event analysis, and comparative insights. The feedback engine 414 adjusts future predictions based on actual sales data and feedback from store managers, ensuring continuous improvement in demand forecasting.

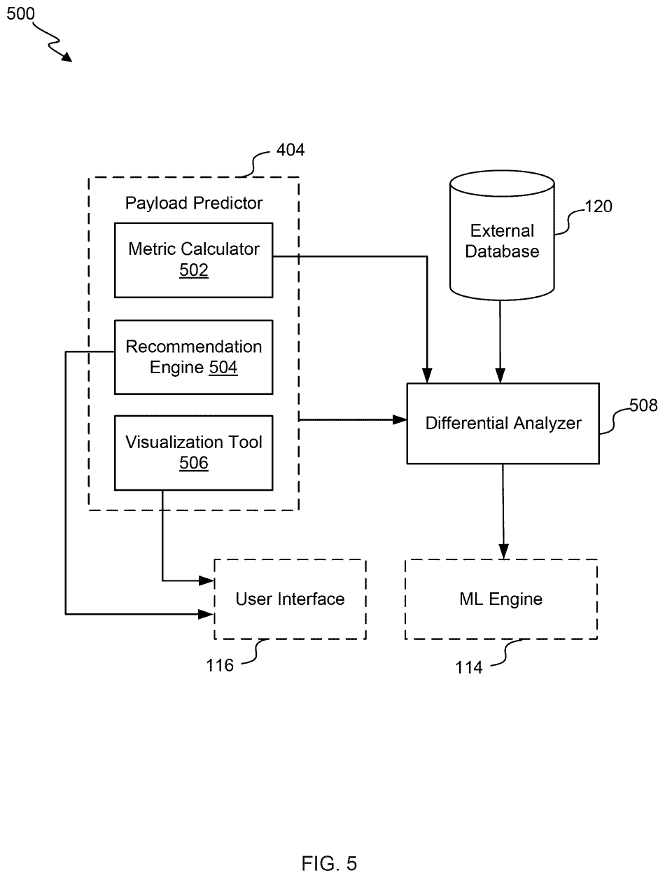

Referring next to FIG. 5, a block diagram for validating 500, the prediction outcome against external telemetry, is shown as an embodiment. A differential analyzer 508 is employed at the utilization prediction system 100 to validate the prediction outcome against the external telemetry. External telemetry, or the distributional data of the competitors or adversaries, is stored in the external database 120 and is utilized to validate the prediction results. To evaluate and validate the accuracy of the prediction models, the external database 120 collects and maintains telemetry from several sources at the cloud network 102. The utilization prediction system 100 may evaluate SKU-level sales changes during comparable events and scale improvements by using the adversary's distribution data outcomes as the control group.

The payload predictor 404 of the ML engine 114 further includes a metric calculator 502, a recommendation engine 504, and a visualization tool 506. The metric calculator 502 computes a confidence metric for the prediction outcome. A higher confidence metric indicates a more accurate prediction outcome. The metric calculator 502 evaluates the prediction outcome by calculating mean absolute error (MAE), root mean square error (RMSE), or coefficient of determination. The MAE measures prediction accuracy, RMSE penalizes large errors in the predicted payload utilization rate, and the coefficient of determination measures the proportion of variance of the payload predictor 404.

The recommendation engine 504 generates recommendations and actionable insights for the agents 106. For example, the recommendations may ask the agents 106 to stock up in case of an increased payload demand due to an upcoming instance. The recommendations are provided to the agents 106 at an agent dashboard on the user interface 116. The visualization tool 506 builds a user-friendly dashboard for supply chain planners to view predictions, event impacts, and actionable recommendations. The visualization tool 506 provides a map at the user interface 116 with targeted nodes to allocate the payload. The visualization tool 506 further creates graphical comparisons between the actual and predicted payload utilization rates for the instance. The visualization tool 506 provides the graphical comparisons at the user interface 116 for the agent's reference. The visualization tool 506 also provides daily or weekly forecasts for SKU-level demand near events and a store map with a view of the aisle sections at the user interface 116 to locate the payload easily.

The prediction outcome and its confidence metric are fed into the differential analyzer 508. The differential analyzer 508 validates the prediction outcome against the external telemetry from the external database 120. The differential analyzer 508 uses metrics, like MAE, RMSE, or precision-recall, for evaluation and calculates the performance metrics of the predictive models. The validation results are used to compare the payload utilization and sales of the organization to the sales of its adversary for the same instance. Total revenue comparison between multiple parties helps improve the payload allocation and transmission schemes and the accuracy of the predictive models. The outcome of the differential analyzer 508 is sent to the ML engine 114. The feedback engine 414 of the ML engine 114 then transforms the prediction outcome based on the inputs from the stage gate and the feedback loop.

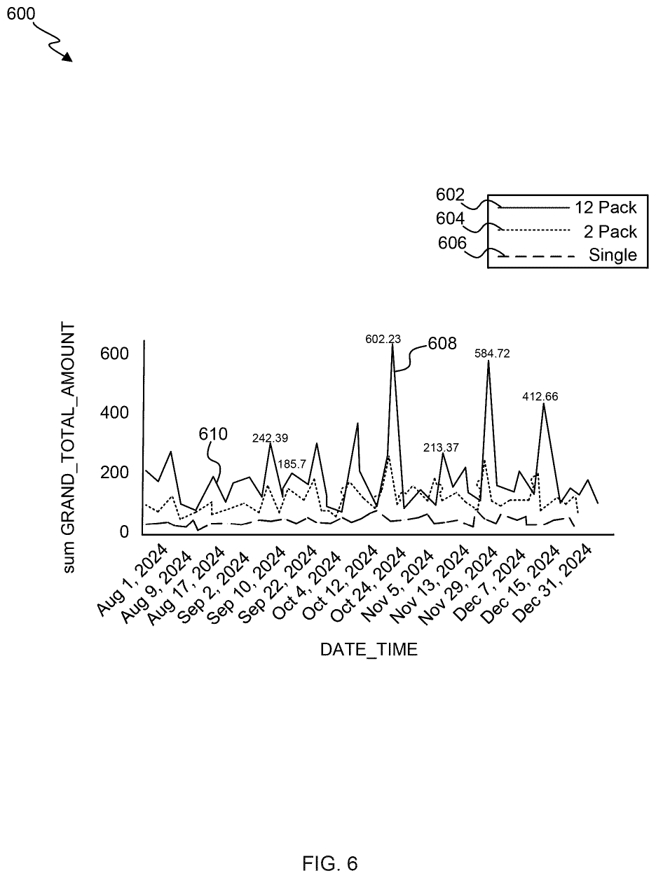

Referring next to FIG. 6, a consumer behavior graph 600 demonstrating payload demand patterns ahead of a football match is shown as an embodiment. The consumer behavior graph 600 corresponds to pre-game and post-game beverage purchase data for the upcoming football match. Section 602 depicts a demand pattern for a 12-pack beverage payload, section 604 depicts a demand pattern for a 6-pack, and section 606 depicts a demand pattern for a single beverage payload at the node 110. The utilization prediction system 100 employs the ML engine 114 to predict the demand patterns for a future instance to allocate the payloads efficiently.

The consumer behavior graph 600 illustrates demand spikes on home game days, highlighting a substantial increase in sales of 12 packs. This trend indicates that fans are likely engaging in bulk buying for tailgating and game-day gatherings. While 6-packs and single cans also experience moderate upticks, they do not match the surge seen in 12-pack purchases, underscoring the preference for larger quantities during these events. Pre-game and post-game buying behavior is also evaluated to determine consumer patterns. The day before home games typically see an increase in sales, suggesting that fans stock up in advance. The pre-game surge at section 608 is followed by a slight decline the day after home games, which indicates a cooldown period in demand or potential stock-outs due to insufficient supply in convenience stores. This pattern emphasizes the importance of timely restocking to meet consumer needs. The variation by the home game date adds another variable to the analysis. Some home games, such as those on November 29, show an extreme surge in 12-pack sales compared to others. This variation may be influenced by factors like the opponent team, weather conditions, or local promotions. For instance, the August 1 home game, which is the season opener, saw increased sales but not as high as later games, possibly due to weather conditions, academic season, or likewise factors. Note that home games consistently drive higher sales, with 12 packs showing the largest sales difference. On average, there is an 87.86% increase in 12-pack sales on home game weekends compared to away game weekends. In contrast, 6-pack sales increased by 14.3% during home games, showing some uplift but not as dramatic as 12 packs. Single can sales remain relatively flat, with only a 0.86% increase, suggesting that bulk purchases dominate home game buying behavior. This pattern suggests focusing on bulk packaging for home game promotions.

On the other hand, away games in section 610 do not exhibit the same spikes as those seen on the home game days. Sales during the away game weekends are steadier but lower, indicating that fans may be engaging in smaller, less organized gatherings. This leads to more balanced pack-size preferences, with no significant surge in any packaging type. The utilization prediction system 100 predicts the payload utilization rate based on datasets that are extracted from different data sources. Details of these datasets are described later. The utilization prediction system 100 makes a post-event analysis and uses historical sales and consumer behavior data to increase the accuracy of the prediction outcome. The utilization prediction system 100 uses consumer behavior patterns to determine the scheduling, allocation, and distribution of different types of payloads to different nodes.

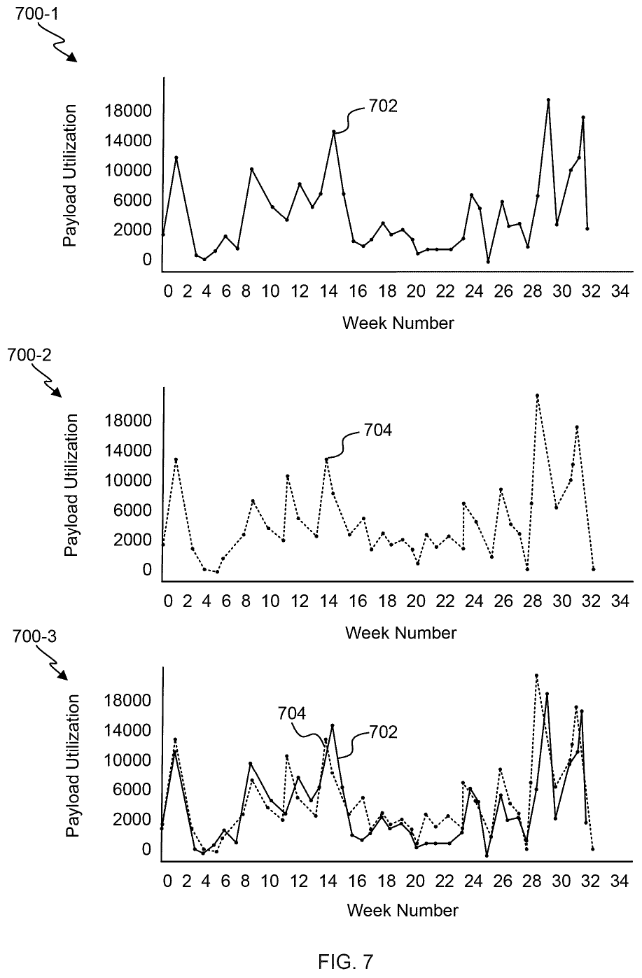

Referring next to FIG. 7, graphical representations of the predicted outcome and an actual utilization rate of the instance and their comparison are shown as an embodiment. A predicted graph 700-1 indicates the predicted outcome and a rate graph 700-2 indicates the actual utilization rate of the instance. A comparison graph 700-3 indicates the comparison between the predicted outcome and the actual utilization rate. The predicted outcome and the actual utilization rate show the supply demand or the demand surge for an exemplary payload and are associated with the instances.

The y-axis represents the predicted utilization rate based on the instance, and the x-axis represents the weeks of the year. To elaborate on the graphical representations, the home and away game days are considered examples. The predicted graph 700-1 shows predicted spikes in product sales on the home game days. The sharp spikes, such as in section 702, are predicted for bulk product sales around the instance, indicating preparations for tailgating and gatherings. Moderate spikes are also predicted before and after the home game days. The ML engine 114 accounts for the pre-game and the post-game customer buying behavior and predicts moderate spikes. A decline after section 702 is predicted possibly as a cooldown period in demand or as a prediction of the stockouts.

The rate graph 700-2 represents the actual utilization rate or the demand surge. The rate graph 700-2 confirms the predicted outcome trends but with variations in magnitude and timing. At section 704, the actual payload utilization slightly differs from the predicted pattern at section 702. As compared to the predicted graph 700-1, the rate graph 700-2 observes increased sales a day before home games, suggesting customers stock up in advance. The comparison graph 700-3 highlights the differences between the predicted outcome and the actual demand. While both graphs show spikes on home game days, the rate graph 700-2 exhibits slightly different surges for certain home games, influenced by factors such as the opponent team, weather, or local promotions. Overall, the home games drive higher sales, and the away games show steady but lower sales, suggesting smaller, less organized gatherings and more balanced product preferences. The comparison graph 700-3 underscores the importance of considering various factors, such as local events, seasonal effects, and public holidays, in demand forecasting to ensure accurate predictions and inventory management.

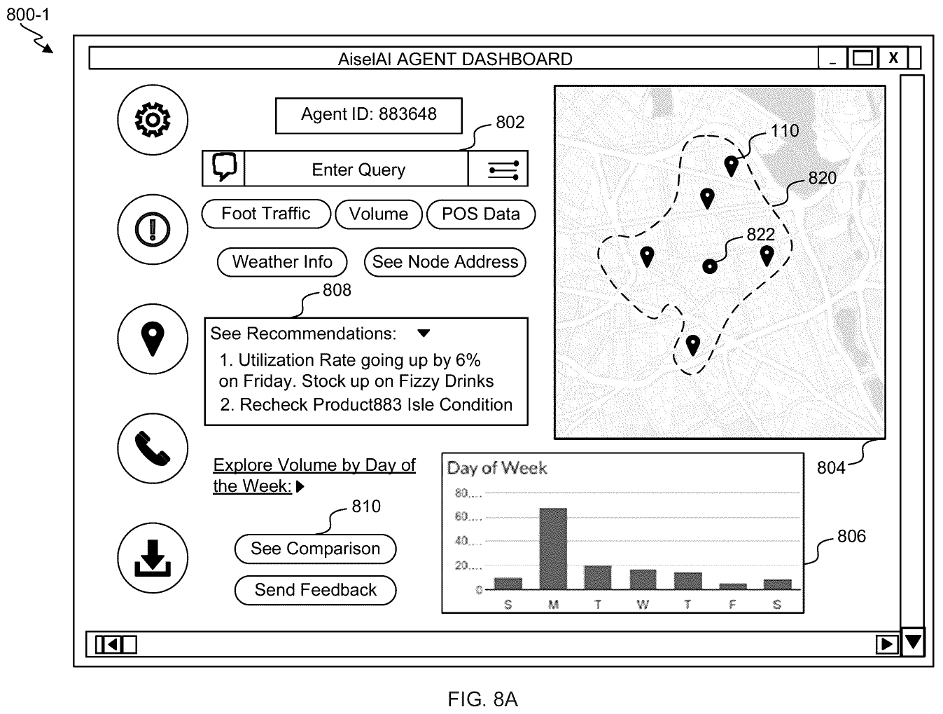

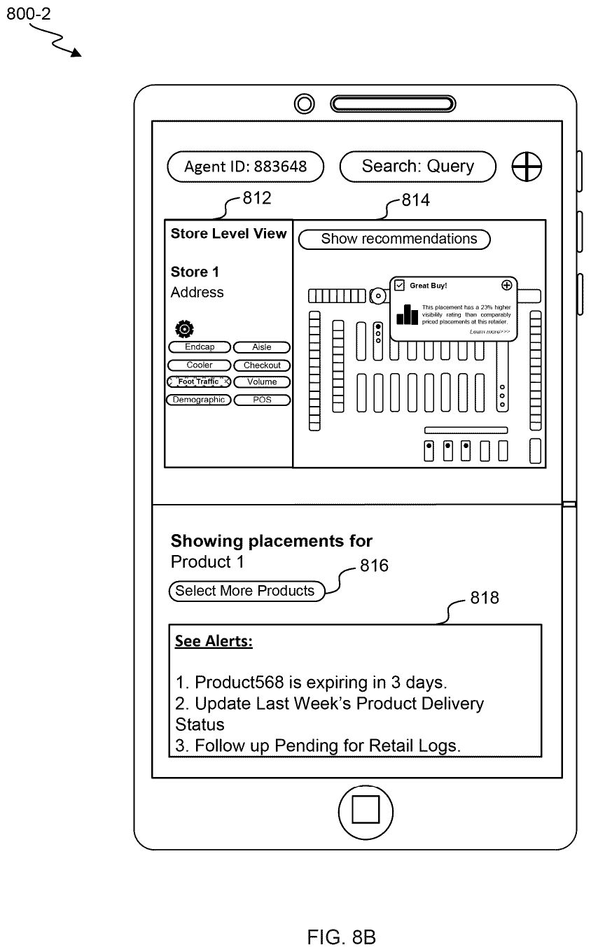

Referring next to FIGS. 8A-B, an agent dashboard 800-1 presented at the user interface 116 for the agent 106 to manage the payload allocation, is shown as an embodiment. The agent dashboard 800-1 at the user interface 116 is for fixed-display devices. The fixed-display devices include and are not limited to desktop computers, laptops, smart monitors, and/or retail consoles. In section 802, agent 106 enters an agent query. The agent query includes the preferences of agent 106 in predicting the payload allocation either against the foot traffic in a geographic area, the POS data of node 110, or the weather conditions on certain days. After entering the agent query, the agent 106 is presented with the prediction outcomes.

At section 804, the agent 106 is provided with the nodes 110 around the instance, shown in section 822, on the map. The node boundary is the polygon shown in section 820. The nodes 110 have their own utilization rates, depending on the magnitude of the instance, the availability of the products, shelf conditions, and/or demographic movements. The node allocator 406 pins the location of the instance and creates the polygon indicating the nearby nodes on the map. The polygon boundary helps the agents 106 in locating the stores with available stock of a particular product/payload. The polygon boundary is not limited to certain nodes or regions; rather, it is based on the magnitude or scale of the instance. A bigger instance will have more nodes in its polygon to cater to the needs of a larger crowd. Furthermore, different nodes at different vertices of the polygon are predicted to have different utilization rates, depending upon the distance from the event, the store location, the event impact on its neighborhood, sales history, consumer interactions, and demographics.

At section 806, the agent dashboard 800-1 shows the sales trend across days of the week. The product sales and the utilization rate are predicted to increase during the weekdays, especially on Monday, and go down by the weekend. At section 808, a recommendation block is shown. As a result of the utilization prediction, the agent dashboard 800-1 provides recommendations for the agents 106. For example, recommending the aisle conditions for the products and/or suggesting a change in the utilization rate during certain periods. At section 810, the agents 106 can compare the predicted outcomes for the agent query against the predicted outcomes when the event impact is not considered. The agent 106 has the option to compare the product's predicted utilization rate for the instance's magnitude against another product during the same time frame.

Referring next to FIG. 8B, the agent dashboard 800-2 at the user interface 116 is for handheld devices. The handheld devices are electronic and portable gadgets including smartphones, tablets, personal digital assistants (PDAs), and/or handheld retail consoles. In section 812, the agent dashboard 800-2 exhibits a store level view based on the predicted outcome. The agents 106 can view the selected source address, aisle conditions, and foot traffic at average hours of the day or, during some instances, the demographics and/or the POS scan data. At section 814, the agent dashboard 800-2 shows some actionable recommendations. For example, a good placement plan for the product might increase the sales before/during the instance. In section 816, agent 106 has the option to select additional products to obtain a comprehensive and comparative placement view and the respective aisle conditions. At section 818, the agent dashboard 800-2 delivers alerts to the agents 106. These alerts include notifications about shelf conditions, predicted sales lifts for stock-keeping units (SKUs) during the events, and insights into consumer behavior patterns.

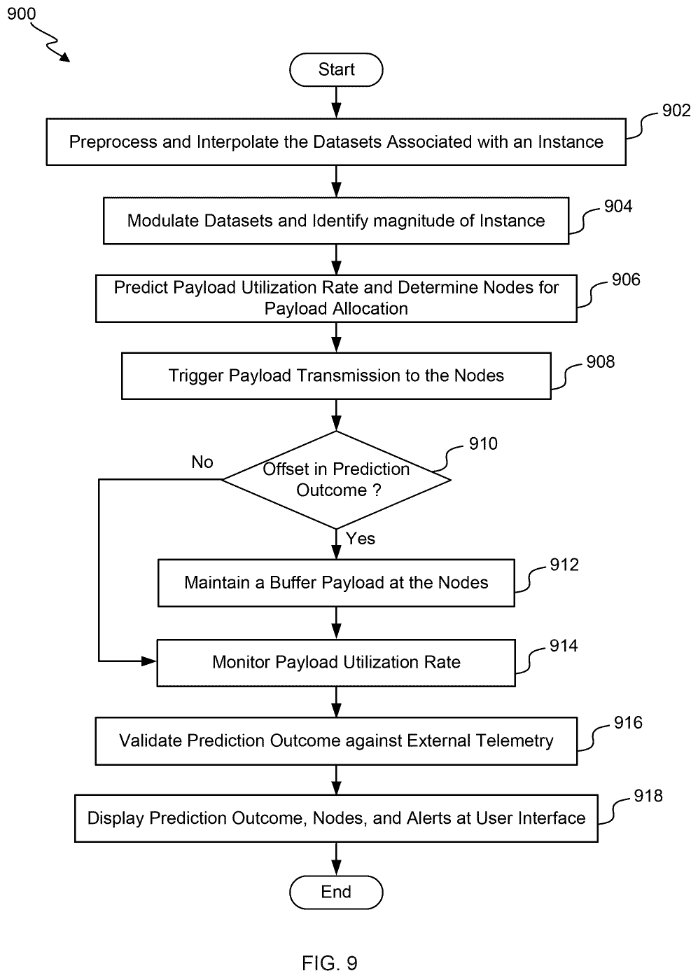

Referring next to FIG. 9, a payload utilization method 900 to manage the resource allocation at the cloud network 102 is shown as an embodiment. At block 902, the preprocessing unit 112 of the utilization prediction system 100 transforms the datasets extracted from different databases across the cloud network 102. The datasets include temporal, geospatial, demographic, and/or storage-based datasets. The preprocessed datasets are sent to interpolator 310, which interpolates the datasets associated with the instance. The instance indicates the projected interruption in the set transmission process that could impact the customer demands, e.g., a concert, a match, a hot summer season, etc. The datasets associated with the instance can include event size, event type, event metadata, out-of-stock products, payload shelf conditions, MAID tracking data, demographic insights, weather data, historical sales, time factors, etc.

At block 904, the ML engine 114 of the utilization prediction system 100 modulates the datasets associated with the instance. The payload predictor 404 determines the instance's magnitude using the dataset's information to estimate the payload utilization rate. For example, a national-level football match will have a higher impact or magnitude than a local-club football match. At block 906, the payload predictor 404 generates a prediction outcome, and the node allocator 406 determines the nodes 110 on the map that are in proximity to the instance for the payload allocation. The prediction outcome corresponds to the payload utilization rate for the instance. Determining the nodes 110 includes outlining the polygon for the nodes based on the prediction outcome.

At block 908, the payload transmitter 408 schedules payload transmission across the allocated nodes within the specified time frame. The payload transmitter 408 triggers payload transmission to the nodes 110 in the polygon based on the prediction outcome. The payload flow is triggered when an irregular surge or decrease in the payload utilization rate is detected. The payload flow is either accelerated or decelerated by the payload channel entities 104 based on the predicted payload utilization rate. At block 910, the offset in the prediction outcome is examined. The offset is any errors in the prediction outcome. During the model training and initial predictions, any offsets can be seen by comparing the predicted outcomes against the actual utilization rates. If any offset is observed, the buffer payload is maintained at block 912. This helps prevent stockouts in case of unexpected utilization spikes while avoiding excessive inventory. In an embodiment, the buffer payload is maintained even if the offset is observed to be zero.

At block 914, the payload utilization rate is monitored via the monitoring engine 410, which continuously monitors the payload utilization rate at the stage gate. The monitoring engine 410 tracks real-time sales data during the instance to ensure inventory levels are sufficient. The monitoring engine 410 uses historical data, market trends, and prediction outcomes to ensure inventory levels align with expected sales. At block 916, the predicted outcome is validated against the external telemetry via the differential analyzer 508. External telemetry is stored in the external database 120 and is utilized to validate the prediction results. To evaluate and validate the accuracy of the prediction models, the external database 120 collects and maintains telemetry from several sources at the cloud network 102. The utilization prediction system 100 may evaluate SKU-level sales changes during comparable events and scale improvements by using the outcomes of the adversary's distribution data as the control group. At block 918, the prediction outcome is displayed at the user interface 116, including the nodes 110 and the event pinned inside the polygon and actionable insights as alerts for the agents 106.

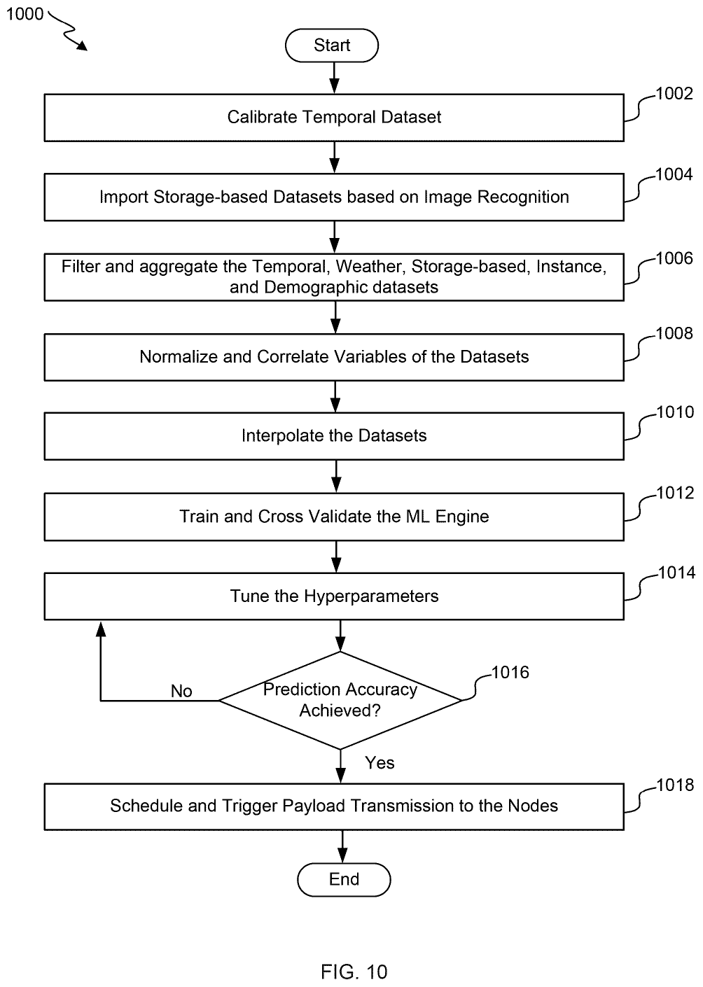

Referring next to FIG. 10, a flow chart 1000 for scheduling and triggering the payload transmission by preprocessing the datasets is shown as an embodiment. At block 1002, the temporal dataset is calibrated. The data filter 302 calibrates the temporal datasets by removing any unrelated information and outliers to maintain the consistency within the dataset. Calibrating the temporal dataset also includes removing the redundant POS scan data for accurate and reliable dataset formation. At block 1004, the storage-based datasets are imported based on the image recognition of the images received from the sensors integrated at the node premises. The camera feeds 210, which provides information about the customer's interaction with the products, and the IoT sensors 212 detect environmental conditions for the products. The camera feeds data, and the IoT sensors data is combined in the storage-based database 214 to create the storage-based dataset.

At block 1006, the datasets from the temporal database 206, the weather database 208, the storage-based database 214, the instance databases 222, and the demographic database 224 are filtered and aggregated. At block 1008, the datasets are normalized and correlated. The normalizer 306 aligns timestamps and standardizes data formats to ensure consistency across the dataset. By normalizing the datasets, the preprocessing unit 112 ensures that all the data points are comparable and can be accurately analyzed. The correlator 308 generates dependency mappings and engineers features, setting up the correlation between the independent and the control variables of the datasets.

At block 1010, the datasets are interpolated. The interpolator 310 takes the processed data and fills in gaps or predicts intermediate values based on the surrounding data. The interpolator 310 identifies the missing data periods, employs the interpolation method, and generates the complete dataset. At block 1012, the ML engine 114 is trained and cross-validated for the complete dataset. The ML engine 114 identifies the magnitude of the instance from multiple datasets and predicts the payload utilization rate based on this magnitude. The confidence metrics for the prediction outcome after the training are calculated, and hyperparameters of the ML engine 114 are fine-tuned based on the prediction outcome and the input from the stage gate and the feedback loop, at block 1014. The fine-tuning selects the appropriate hyperparameters for the ML engine 114 and controls how the ML engine 114 learns from the complete dataset.

At block 1016, the utilization prediction engine 100 checks if the prediction accuracy is achieved. If not, the hyperparameters are fine-tuned again at the block 1014. Otherwise, the payload transmission is scheduled and triggered at block 1018. The ML engine 114 determines the nodes on the map inside the polygon and schedules the transmission across these nodes within the specified time frame. The ML engine 114 triggers payload transmission based on the predicted utilization rate and maintains the buffer payload at the nodes to offset any errors in the prediction outcome.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process that is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine-readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read-only memory (ROM), random access memory (RAM), magnetic RAM, core memory, magnetic disk storage mediums, optical storage mediums, flash memory devices and/or other machine-readable mediums for storing information. The term “machine-readable medium” includes but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as a limitation on the scope of the disclosure.

We claim:

1. A payload allocation method for a cloud network, the payload allocation method comprises:
preprocessing a plurality of datasets extracted from a plurality of databases, wherein the plurality of datasets comprises:
a plurality of temporal, geospatial, demographical, and/or storage-based datasets;
interpolating the plurality of datasets associated with an instance, wherein the instance indicates a projected interruption in a set transmission process;
modulating the plurality of datasets associated with the instance via a machine learning engine, wherein the machine learning engine is operable to:
identify, from the plurality of datasets, a magnitude of the instance;
based on the magnitude, predict a payload utilization rate for the instance;
determine a plurality of nodes at a map for payload allocation;
schedule payload transmission across the plurality of nodes within a time frame;
trigger the payload transmission to the plurality of nodes based on a prediction outcome that corresponds to the payload utilization rate for the instance;
maintain a buffer payload at the plurality of nodes, wherein the buffer payload is an offset for an error in the prediction outcome;
monitor the payload utilization rate for the instance at a stage gate; and
transform the prediction outcome based on an input from the stage gate and a feedback loop;
validating the prediction outcome against an external telemetry; and
displaying the prediction outcome, the plurality of nodes, and a plurality of alerts at a user interface.

2. The payload allocation method for the cloud network of claim 1, wherein the plurality of temporal datasets comprises information of the instance recorded at a plurality of timestamps that provide a baseline pattern to the machine learning engine.

3. The payload allocation method for the cloud network of claim 1, wherein the plurality of geospatial datasets comprises information of an instance timeline, foot traffic count, and geolocated movement patterns sourced from electronic device tracking.

4. The payload allocation method for the cloud network of claim 1, wherein the plurality of demographic datasets comprises geographic coordinates including latitude and longitude, geographic boundaries, and/or demographic variables for the plurality of nodes.

5. The payload allocation method for the cloud network of claim 1, wherein the plurality of storage-based datasets comprises information about storage capacity and payload condition at a node and is determined from image recognition of a plurality of images of a plurality of payloads, wherein the plurality of images is received via a plurality of sensors integrated within a node premise.

6. The payload allocation method for the cloud network of claim 1, wherein the determining of the plurality of nodes at the map includes outlining a polygon for the plurality of nodes in proximity to the instance, based on the prediction outcome.

7. The payload allocation method for the cloud network of claim 1, wherein the machine learning engine comprises a plurality of hyperparameters fine-tuned based on the prediction outcome and the input from the stage gate and the feedback loop.

8. The payload allocation method for the cloud network of claim 1, wherein the monitoring of the payload utilization rate for the instance comprises adjusting the payload allocation based on real-time instance data.

9. A payload allocation system of a cloud network, the payload allocation system is operable to:
preprocess a plurality of datasets extracted from a plurality of databases, wherein the plurality of datasets comprises:
a plurality of temporal, geospatial, demographical, and/or storage-based datasets;
interpolate the plurality of datasets associated with an instance, wherein the instance indicates a projected interruption in a set transmission process;
modulate the plurality of datasets associated with the instance via a machine learning engine, wherein the machine learning engine is operable to:
identify, from the plurality of datasets, a magnitude of the instance;
based on the magnitude, predict a payload utilization rate for the instance;
determine a plurality of nodes at a map for payload allocation;
schedule payload transmission across the plurality of nodes within a time frame;
trigger payload transmission to the plurality of nodes based on a prediction outcome that corresponds to the payload utilization rate for the instance;
maintain a buffer payload at the plurality of nodes, wherein the buffer payload is an offset for an error in the prediction outcome;
monitor the payload utilization rate for the instance at a stage gate; and
transform the prediction outcome based on an input from the stage gate and a feedback loop;
validate the prediction outcome against an external telemetry; and
display the prediction outcome, the plurality of nodes, and a plurality of alerts at a user interface.

10. The payload allocation system of the cloud network of claim 9, wherein the plurality of temporal datasets comprises information of the instance recorded at a plurality of timestamps that provide a baseline pattern to the machine learning engine.

11. The payload allocation system of the cloud network of claim 9, wherein the plurality of geospatial datasets comprises information of an instance timeline, foot traffic count, and geolocated movement patterns sourced from electronic device tracking.

12. The payload allocation system of the cloud network of claim 9, wherein the plurality of demographic datasets comprises geographic coordinates including latitude and longitude, geographic boundaries, and/or demographic variables for the plurality of nodes.

13. The payload allocation system of the cloud network of claim 9, wherein the plurality of storage-based datasets comprises information about storage capacity and payload condition at a node and is determined from image recognition of a plurality of images of a plurality of payloads, wherein the plurality of images is received via a plurality of sensors integrated within a node premise.

14. The payload allocation system of the cloud network of claim 9, wherein the machine learning engine comprises a plurality of hyperparameters fine-tuned based on the prediction outcome and the input from the stage gate and the feedback loop.

15. A computer-readable media having computer-executable instructions embodied thereon that, when executed by one or more processors, facilitate a payload allocation method to manage payload allocation at a cloud network, the payload allocation method comprises:
preprocessing a plurality of datasets extracted from a plurality of databases, wherein the plurality of datasets comprises:
a plurality of temporal, geospatial, demographical, and/or storage-based datasets;
interpolating the plurality of datasets associated with an instance, wherein the instance indicates a projected interruption in a set transmission process;
modulating the plurality of datasets associated with the instance via a machine learning engine, wherein the machine learning engine is operable to:
identify, from the plurality of datasets, a magnitude of the instance;
based on the magnitude, predict a payload utilization rate for the instance;
determine a plurality of nodes at a map for payload allocation;
schedule payload transmission across the plurality of nodes within a time frame;
trigger payload transmission to the plurality of nodes based on a prediction outcome that corresponds to the payload utilization rate for the instance;
maintain a buffer payload at the plurality of nodes, wherein the buffer payload is an offset for an error in the prediction outcome;
monitor the payload utilization rate for the instance at a stage gate; and
transform the prediction outcome based on an input from the stage gate and a feedback loop;
validating the prediction outcome against an external telemetry; and
displaying the prediction outcome, the plurality of nodes, and a plurality of alerts at a user interface.

16. The computer-readable media of claim 15, wherein the plurality of temporal datasets comprises information of the instance recorded at a plurality of timestamps that provide a baseline pattern to the machine learning engine.

17. The computer-readable media of claim 15, wherein the plurality of geospatial datasets comprises information of an instance timeline, foot traffic count, and geolocated movement patterns sourced from electronic device tracking.

18. The computer-readable media of claim 15, wherein the plurality of demographic datasets comprises geographic coordinates including latitude and longitude, geographic boundaries, and/or demographic variables for the plurality of nodes.

19. The computer-readable media of claim 15, wherein the determining of the plurality of nodes at the map includes outlining a polygon for the plurality of nodes in proximity to the instance, based on the prediction outcome.

20. The computer-readable media of claim 15, wherein the monitoring of the payload utilization rate for the instance comprises adjusting the payload allocation based on real-time instance data.
